(19) United States
(12) Patent Application Publication
(10) Pub. No.: US 2013/0169788 A1
(43) Pub. Date: Jul. 4, 2013

(54) MICROSCOPE, IMAGE ACQUISITION APPARATUS, AND IMAGE ACQUISITION SYSTEM

(71) Applicants: Toshihiko Tsuji, Utsunomiya-shi (JP); Hirofumi Fujii, Toyono-gun (JP); Shun Mochizuki, Utsunomiya-shi (JP)

(72) Inventors: Toshihiko Tsuji, Utsunomiya-shi (JP); Hirofumi Fujii, Toyono-gun (JP); Shun Mochizuki, Utsunomiya-shi (JP)

(73) Assignee: CANON KABUSHIKI KAISHA, Tokyo (JP)

(21) Appl. No.: 13/823,062

(22) PCT Filed: Oct. 11, 2011
(86) PCT No.: PCT/JP2011/073774

§ 371 Date: Mar. 13, 2013

(30) Foreign Application Priority Data
Oct. 29, 2010 (JP) 2010-243802
Oct. 29, 2010 (JP) 2010-243803
Sep. 1, 2011 (JP) 2011-190375

(51) Int. Cl. G02B 21/36

(52) U.S. Cl. CPC G02B 21/365
USPC 348/79

(57) ABSTRACT

A microscope 1 includes an illumination device 10 for illuminating a object 30, an optical system 40 for forming an image of the object 30, and an imaging device 50 for capturing the image of the object 30. The imaging device 50 includes a plurality of imaging units. Each of the imaging units includes an image sensor and a movement mechanism for moving the image sensor.

### TECHNICAL FIELD

The present invention relates to a microscope, an image acquisition apparatus, and an image acquisition system.

### BACKGROUND ART

In the field of pathology, an image acquisition system has attracted attention, which captures an image of a slide to acquire a digital image (virtual slide image) by using a microscope (digital microscope) and displays on a display unit the digital image with high resolution.

A microscope is demanded to speedily capture an image of a slide with high resolution. To meet this demand, it is necessary to capture an image of as wide a region on the slide as possible at one time with high resolution. PTL 1 discusses a microscope employing a wide-field high-resolution objective lens and arranging an image sensor group in the field of the objective lens.

PTL 2 discusses a microscope which, to efficiently acquire a high-resolution digital image, captures an image of a slide with low resolution as preliminary measurement, and then captures an image of the slide only for an existence region on the slide where a sample (biological sample) exists with high resolution. PTL 3 discusses a microscope which, when capturing an image of a slide including a plurality of biological samples, changes the focus of an objective lens for each biological sample.

### CITATION LIST

### Patent Literature

PTL 1 Japanese Patent Application Laid-Open No. 2009-003016
PTL 2 Japanese Patent Application Laid-Open No. 2007-310231
PTL 3 Japanese Patent Application Laid-Open No. 2007-233098

### SUMMARY OF INVENTION

### Technical Problem

Increasing the resolution of an objective lens decreases the depth of focus of the objective lens. Sealing a sample between a slide glass and a cover glass by gluing them may change the shape of the cover glass and the sample. If the sample is deformed and its surface undulates, a part of the sample does not fit into the depth of focus of the objective lens, disabling acquisition of a preferable image having little blur.

### Solution to Problem

The present invention is directed to a microscope capable of acquiring a preferable digital image having little blur even when a wide-field high-resolution objective lens is used.

According to an aspect of the present invention, a microscope for capturing an image of an object includes an illumination device configured to illuminate the object, an optical system configured to focus an image of the object, and an imaging device for capturing an image of the object, wherein the imaging device includes a plurality of imaging units, and wherein each of the imaging units includes an image sensor and a movement mechanism for moving the image sensor.

### Advantageous Effects of Invention

A microscope capable of acquiring a preferable digital image having little blur can be provided.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an image acquisition system 100.

FIG. 2A is a top view illustrating a test object 30.

FIG. 2B is a sectional view illustrating the test object 30.

FIG. 3 illustrates an objective lens 40.

FIG. 4A is a top view illustrating an imaging device 50.

FIG. 4B is a sectional view illustrating the imaging device 50.

FIG. 5 illustrates a measuring apparatus 2.

FIG. 6 illustrates transmitted light T and reflected light R on the test object 30.

FIG. 7 illustrates an existence region E where the test object 30 exists.

FIG. 8A is a sectional view illustrating a Shack-Hartmann wave front sensor 902 (when incident light has a planar wave front W).

FIG. 8B is a sectional view illustrating the Shack-Hartmann wave front sensor 902 (when incident light has a distorted wave front W).

FIG. 9A is a top view illustrating a detector array 922 (when incident light has a planar wave front W).

FIG. 9B is a top view illustrating the detector array 922 (when incident light has a distorted wave front W).

FIG. 10 illustrates a measuring apparatus 2a which is a variation of the measuring apparatus 2.

FIG. 11 is a schematic view illustrating an in-focus curved surface.

FIG. 12A illustrates an in-focus curve of an image of a sample 302.

FIG. 12B is a top view illustrating an image sensor group 555.

FIG. 13A illustrates an in-focus curve of an image of the sample 302, and imaging surfaces of image sensors 501a to 501d.

FIG. 13B is a sectional view illustrating the imaging device 50.

FIG. 13C illustrates an in-focus curve of an image of the sample 302 and imaging surfaces of the image sensors 501a to 501d.

FIG. 13D is a sectional view illustrating the imaging device 50.

FIG. 14 illustrates an imaging device 50a which is a variation of the imaging device 50.

FIG. 15 is a flow chart illustrating an operation of an image acquisition apparatus.

FIG. 16A illustrates an in-focus curve of an image of the sample 302 and imaging surfaces of the image sensors 501a to 501d.

FIG. 16B is a sectional view illustrating the imaging device 50.

FIG. 16C is a sectional view illustrating an imaging device 50b which is a variation of the imaging device 50.

### DESCRIPTION OF EMBODIMENTS

Various exemplary embodiments, features, and aspects of the invention will be described in detail below with reference to the drawings.

An image acquisition apparatus according to an aspect of the present invention includes a plurality of image sensors and a plurality of movement mechanisms and is configured so that each of the movement mechanisms moves each of the image sensors.

A configuration with which each of the movement mechanisms moves each of the image sensors will specifically be described below. One or more (typically three as in a case described below) of the movement mechanisms are connected to one image sensor. The one or more movement mechanisms change the position and/or inclination of one image sensor. As a most typical case, one or more movement mechanisms are connected to all of the image sensors enabling independent control of the position and/or inclination of each image sensor.

Preferable exemplary embodiments of the present invention will be described below with reference to accompanying drawings. In each drawing, identical elements are denoted by the same reference numerals and duplicated explanations will be omitted.

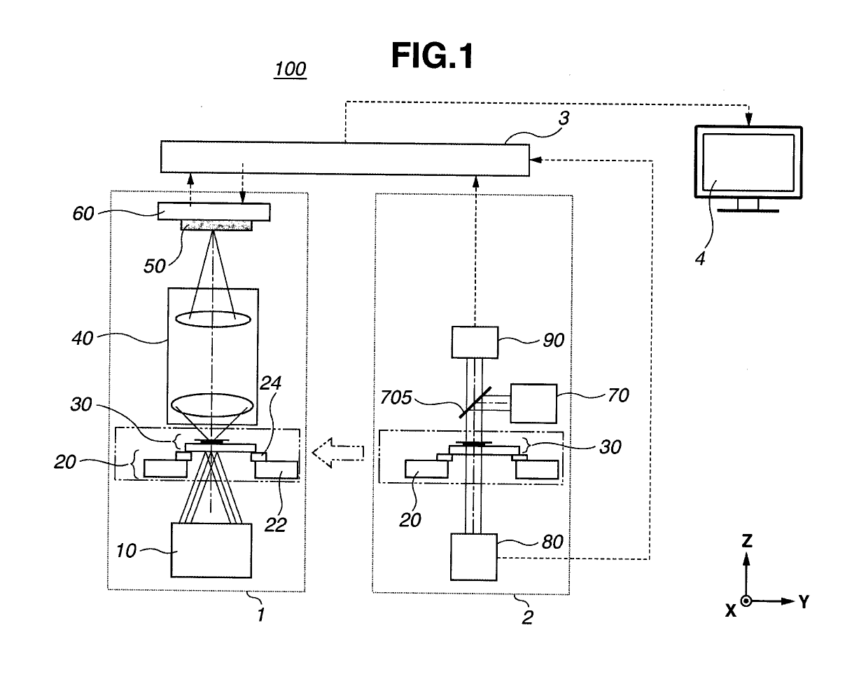

FIG. 1 illustrates an image acquisition system 100. The image acquisition system 100 according to the present exemplary embodiment will be described below with reference to FIG. 1. The image acquisition system 100 captures an image of a test object (slide) and displays the image.

The image acquisition system 100 includes a microscope (digital microscope) 1 for capturing an image of a slide 30, a measuring apparatus 2 for performing preliminary measurement on the slide 30, a control apparatus 3 for controlling the microscope 1 and the measuring apparatus 2 to create a digital image, and a display apparatus 4 for displaying the digital image. The image acquisition system 100 first performs preliminary measurement on the slide 30 via the measuring apparatus 2 and then captures an image of the slide 30 via the microscope 1. The microscope 1, the measuring apparatus 2, and the control apparatus 3 constitute the image acquisition apparatus for acquiring a digital image of the slide 30.

The microscope 1 will be described below. The microscope 1 includes an illumination device 10 for illuminating the slide 30, an objective lens 40 for forming an image of the slide 30, an imaging device 50 for capturing an image of the slide 30, an imaging device stage 60 for holding the imaging device 50, and a slide stage 20 for holding and moving the slide 30.

The illumination device 10 includes a light source unit and an optical system for guiding light from the light source unit to the slide 30. The light source unit may be a white light source or a light source capable of selecting R, G, and B wavelength light. In the present exemplary embodiment, a light-emitting diode (LED) light source capable of selecting R, G, and B light is used.

The optical system includes a collimator for collimating divergent light from the light source unit to parallel light, and a Kohler illumination system for guiding the parallel light and applying Kohler illumination to the slide 30. The optical system may include an optical filter. The illumination device 10 is preferably configured to enable switching between regular illumination and annular illumination for the slide 30.

The slide stage 20 includes a holding member (not illustrated) for holding the slide 30, an XY stage 22 for moving the holding member in the X and Y directions, and a Z stage 24 for moving the holding member in the Z direction. The Z direction is an optical axis direction of the objective lens 40. The X and Y directions are directions perpendicular to the optical axis direction.

Each of the XY stage 22 and the Z stage 24 is provided with an aperture through which light from the illumination device 10 passes. The slide stage 20 is reciprocatingly movable between the microscope 1 and the measuring apparatus 2.

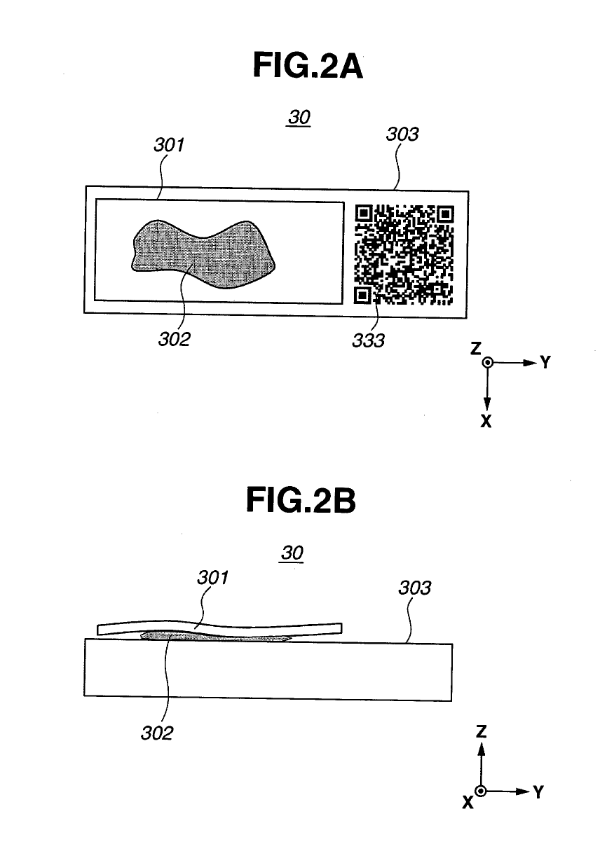

FIG. 2A is a top view illustrating a test object 30. FIG. 2B is a sectional view illustrating the test object 30. The slide glass (preparation) 30, an example of the test object, includes a cover glass 301, a sample 302, and a slide glass 303, as illustrated in FIGS. 2A and 2B.

The sample 302 (a biological sample such as a tissue section) placed on the slide glass 303 is sealed by the cover glass 301 and an adhesive agent (not illustrated). A label (bar code) 333 recording information necessary to manage the slide 30 (sample 302), such as the identification number of the slide glass 303 and the thickness of the cover glass 301, may be stuck onto the slide glass 303. Although, in the present exemplary embodiment, the slide 30 is illustrated as an example of the test object subjected to image acquisition, other objects may be used as a test object.

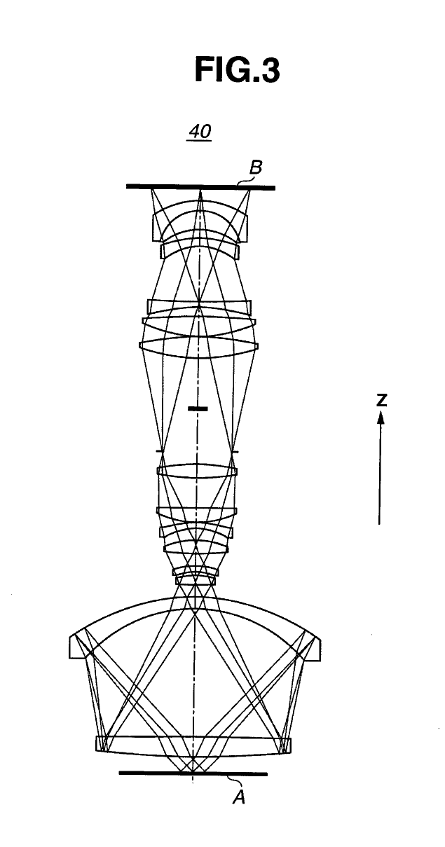

FIG. 3 illustrates the objective lens 40. The objective lens 40 is an imaging optical system for magnifying the image of the slide 30 with a predetermined magnification and forming the image on an imaging surface of the imaging device 50. Specifically, as illustrated in FIG. 3, the objective lens 40 includes lenses and mirrors and is configured to focus an image of an object placed on an object plane A onto an image plane B.

In the present exemplary embodiment, the objective lens 40 is disposed so that the slide 30 is optically conjugate with the imaging surface of the imaging device 50. The object is equivalent to the slide 30 and the image plane B is equivalent to the imaging surface of the imaging device 50. The numerical aperture NA on the object plane side of the objective lens 40 is preferably 0.7 or more. The objective lens 40 is preferably configured so that at least a 10 mm×10 mm square region of the slide can be preferably imaged onto the image plane at one time.

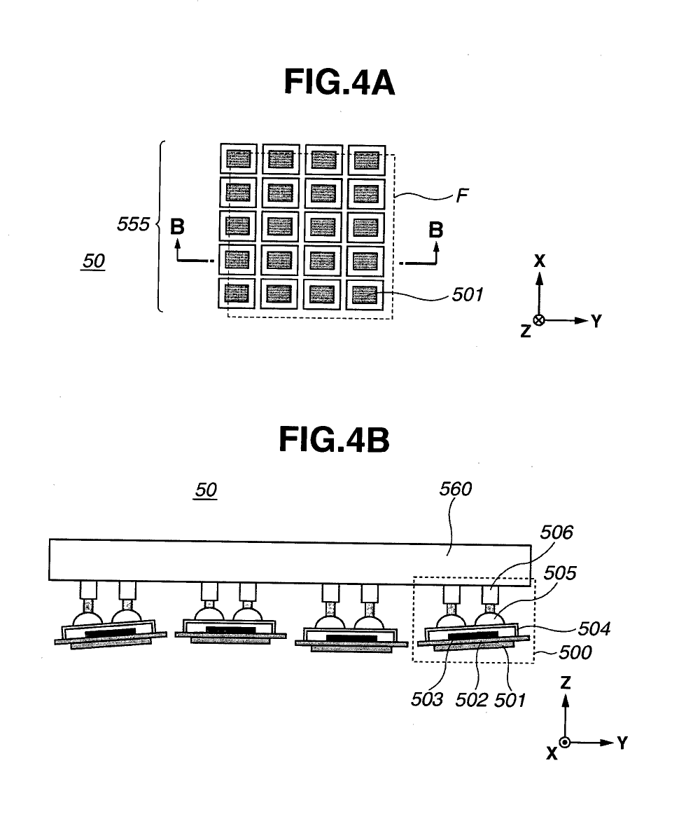

FIG. 4A is a top view illustrating the imaging device 50. As illustrated in FIG. 4A, the imaging device 50 includes an image sensor group 555 composed of a plurality of image sensors 501 two-dimensionally arranged (in a matrix) within a field F of the objective lens 40. The image sensors 501 are configured so as to simultaneously capture images of a plurality of different portions of the slide 30.

An image sensor 501 may be a charge-coupled device (CCD) sensor or a metal-oxide semiconductor (CMOS) device sensor. The number of image sensors 501 mounted on the imaging device 50 is suitably determined by the area of the field F of the objective lens 40. The arrangement of the image sensors 501 is also suitably determined by the shape of the field F of the objective lens 40, and the shape and configuration of the image sensor 501.

In the present exemplary embodiment, to make explanation easier to understand, the image sensor group 555 includes 5×4 CMOS device sensors arranged in the X and Y directions. With a general imaging device 50, arranging the image sensors 501 without clearances is impossible because of substrate surface around the imaging surface of an image sensor 501. So, an image acquired by single image capturing by the imaging device 50 includes missing portions corresponding to clearances between the image sensors 501.

Accordingly, the image acquisition apparatus according to the present exemplary embodiment captures images a plurality of number of times while moving the slide stage 20, i.e., changing a relative position between the slide 30 and the image sensor group 555, to fill in clearances between the image sensors 501, thus acquiring an image of the sample 302 without missing portions. Performing this operation at higher speed enables capturing an image of a wider region in a shorter image capturing time.

Since the imaging device 50 is disposed on the imaging device stage 60, the imaging device stage 60 may be moved instead of moving the slide stage 20 to change the relative position between the slide 30 and the image sensor group 555.

The imaging device 50 further includes a moving unit composed of a plurality of movement mechanisms. Each of the movement mechanisms moves the imaging surface of each of the image sensors 501. An image sensor 501 will specifically be described below with reference to FIG. 4B.

FIG. 4B is a cross sectional view taken along a B-B line of FIG. 4A. As illustrated in FIG. 4B, the image sensor 501 is provided with a substrate 502, an electric circuit 503, a holding member 504, connecting members 505, and moving members (cylinders) 506, thus forming an imaging unit 500. The moving members 506 are disposed on a top plate 560. The connecting members 505 and the moving members 506 constitute a movement mechanism. The image sensor 501 is provided with three connecting members 505 and three moving members 506. (FIG. 4B illustrates two out of three connecting members 505 and two out of three moving members 506.)

The connecting members 505 are fixed to the holding member 504 and rotatable centering on a connection portion with the moving members 506. So, the movement mechanism is configured to change both the Z-directional position and the inclination of the imaging surface of the image sensor 501.

The imaging device stage 60 is movable in each of the X, Y, and Z directions, and configured to adjust the position of the image sensor group 555. The imaging device stage 60 is rotatable in each of the X, Y, and Z axes, and configured to adjust the inclination and rotation of the image sensor group 555.

The measuring apparatus 2 will be described below. As illustrated in FIG. 1, the measuring apparatus 2 includes an illumination unit 70 for illuminating the slide 30, an existence region measuring unit 80 for measuring a region (existence region) of the slide 30 where a sample exists, and a surface shape measuring unit 90 for measuring the surface shape of the slide 30.

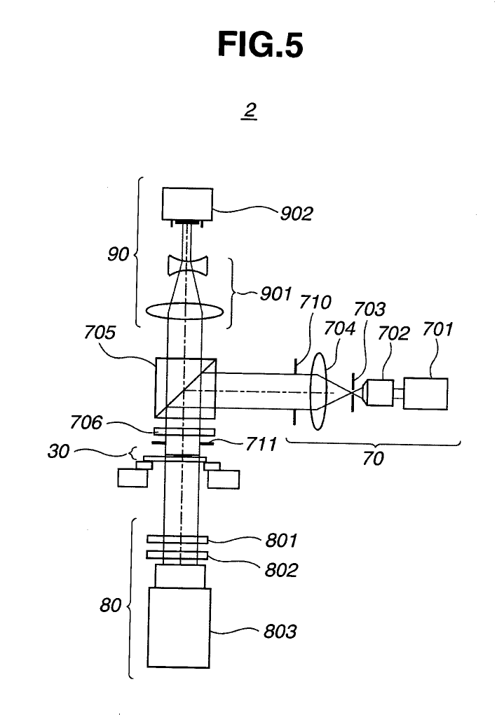

FIG. 5 illustrates the measuring apparatus 2. As illustrated in FIG. 5, the illumination unit 70 includes alight source 701, a condenser lens 702, a pinhole plate 703, a collimator lens 704, an aperture 710, a polarizing beam splitter 705, a quarter wave plate 706, and a diaphragm 711. Light from the light source 701 is condensed onto a pinhole of the pinhole plate 703 by the condenser lens 702. Light (spherical wave) from the pinhole is shaped into parallel light (planar wave) by the collimator lens 704.

The parallel light passes through the diaphragm 710, reflects by the polarizing beam splitter 705, passes through the quarter wave plate 706 and the diaphragm 711, and enters the slide 30.

The light source may be an LED light source or a semiconductor laser device. The pinhole plate 703 is configured to emit a spherical wave that can be considered as an ideal spherical wave. The parallel light from the illumination unit 70 is configured to illuminate at least the entire region of the cover glass 301.

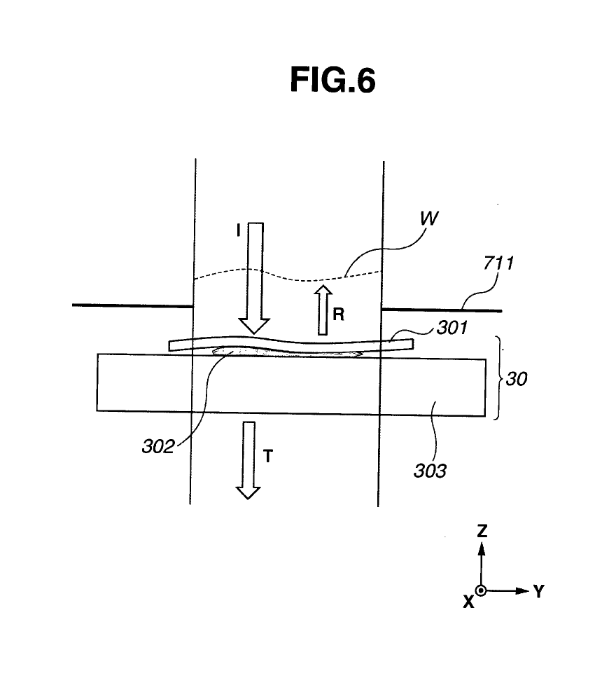

FIG. 6 illustrates transmitted light T and reflected light R on the test object 30. As illustrated in FIG. 6, incident light I (planar wave) entering the cover glass 301 of the slide 30 is split into the transmitted light T that passes through the slide 30 and the reflected light R reflected by the surface of the cover glass 301.

A wave front W of the reflected light R is distorted corresponding to an undulation on the surface of the cover glass 301. In the present exemplary embodiment, the transmitted light T enters the existence region measuring unit 80, and the reflected light R passes through the diaphragm 711 and the quarter wave plate 706, passes through the polarizing beam splitter 705, and enters the surface shape measuring unit 90.

As illustrated in FIG. 5, the existence region measuring unit 80 includes a filter 801 and a camera 803. The filter 801 is an ND filter which adjusts the light amount entering the camera 803. The camera 803, for example a CCD camera, is configured to capture an image of at least the entire region of the cover glass 301.

Using laser as the light source 701 may cause speckles. In such a case, it is preferable to dispose a random phase plate 802 in the optical path of the transmitted light T and move (for example, rotate) the random phase plate 802 by using a movement mechanism (not illustrated).

The light amount that passes through the sample 302 out of light entering the camera 803 is less than the light amount that does not pass through the sample 302. So, the existence region of the sample 302 of the slide 30 can be obtained by using a contrast difference between the light that passed through the cover glass 301, the sample 302, and the slide glass 303, and the light that passed through the cover glass 301 and the slide glass 303.

For example, image information captured by the camera 803 is input to the control apparatus 3, and the control apparatus 3 performs an operation for recognizing a region having a luminance equal to or less than a predetermined threshold value L as an existence region of the sample 302.

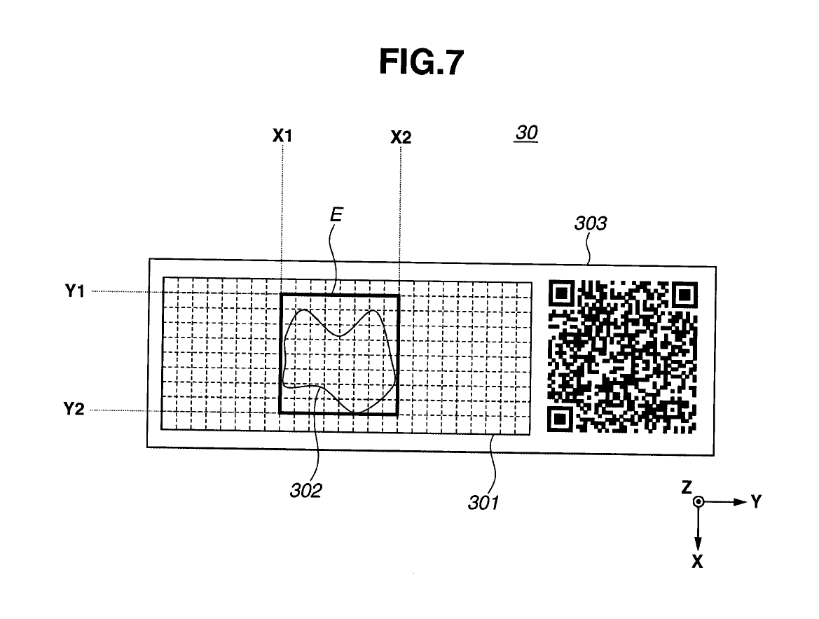

FIG. 7 illustrates an existence region E where the test object 30 exists. As illustrated in FIG. 7, when defining the existence region E as a rectangular region, the existence region E where the sample 302 exists can be determined by calculating coordinate values X1, X2, Y1, and Y2.

As illustrated in FIG. 5, the surface shape measuring unit 90 includes a variable optical system 901 and a wave front sensor 902 for measuring a wave front of incident light. The variable optical system 901 is configured so that the slide 30 is optically conjugate with the wave front sensor 902 and is configured to vary the imaging magnification.

Although, in the present exemplary embodiment, a Shack-Hartmann wave front sensor is used as the wave front sensor 902, an interferometer (for example, a shearing interferometer) may be used instead of the Shack-Hartmann wave front sensor to detect the wave front of the reflected light R.

The use of a wave front sensor capable of detecting the surface of the cover glass 301 at one time enables speedily and accurately measuring the surface shape of the cover glass 301.

Since the surface shape measuring unit 90 measures the surface shape of the cover glass 301 by using the reflected light R from the surface of the cover glass 301, a measurement result is affected by the sample 302 and the slide glass 303 to less extent than in a case where the surface shape is measured by using the transmitted light T. So, the surface shape measuring unit 90 disposed as illustrated in FIG. 5 enables more accurately measuring the surface shape of the cover glass 301.

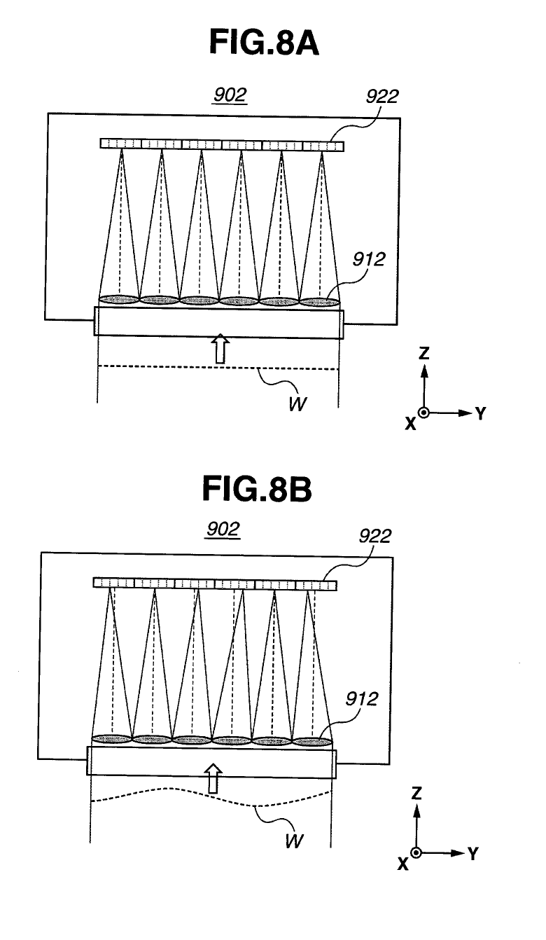

FIGS. 8A and 8B illustrate the Shack-Hartmann wave front sensor 902. As illustrated in FIGS. 8A and 8B, the Shack-Hartmann wave front sensor 902 includes a lens array 912 composed of a plurality of two-dimensionally arranged lenses and a detector array 922 composed of a plurality of two-dimensionally arranged detectors.

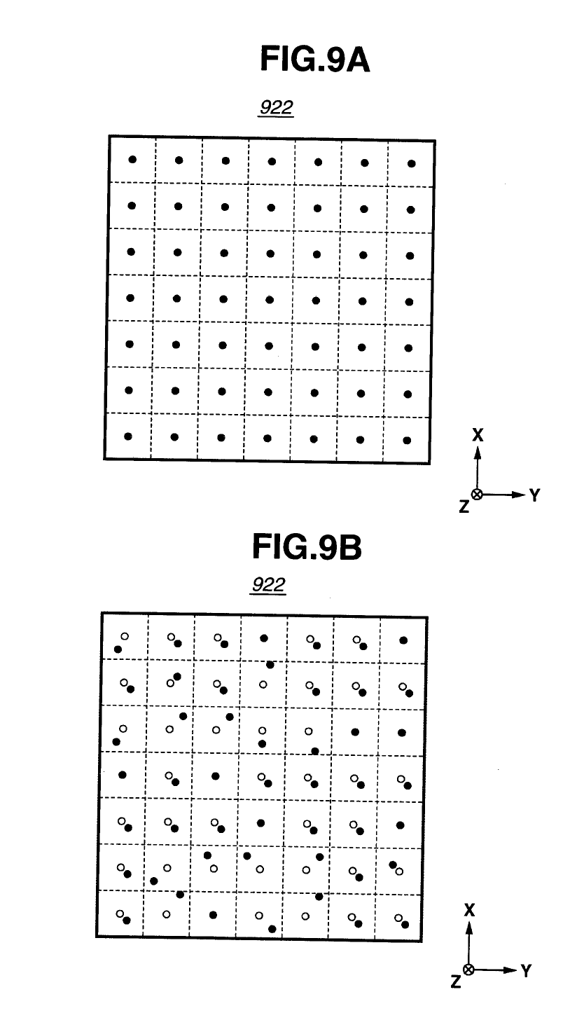

The lenses of the lens array 912 split the wave front of the incident light (reflected light R) and condense pieces of split light onto respective detectors of the detector array 922. A method for measuring the surface shape by using the Shack-Hartmann wave front sensor 902 will be described below with reference to FIGS. 8A to 9B. FIGS. 9A and 9B are top views of the detector array 922 of the Shack-Hartmann wave front sensor 902. A white circle indicates the center of each detector and a black circle indicates a condensing position of each detector.

When the incident light has a planar wave front W as illustrated in FIG. 8A, each piece of split light is condensed just onto the center of each detector (on the optical axis of each lens) as illustrated in FIG. 9A. However, when the incident light has a distorted wave front W as illustrated in FIG. 8B, the condensing position of the incident light deviates from the center of each detector as illustrated in FIG. 9B depending on the inclination of each piece of split light. The control apparatus 3 calculates a wave front shape of the incident light based on a measured value of the shift amount of the condensing position and obtains the surface shape of the cover glass 301 from the calculated wave front shape.

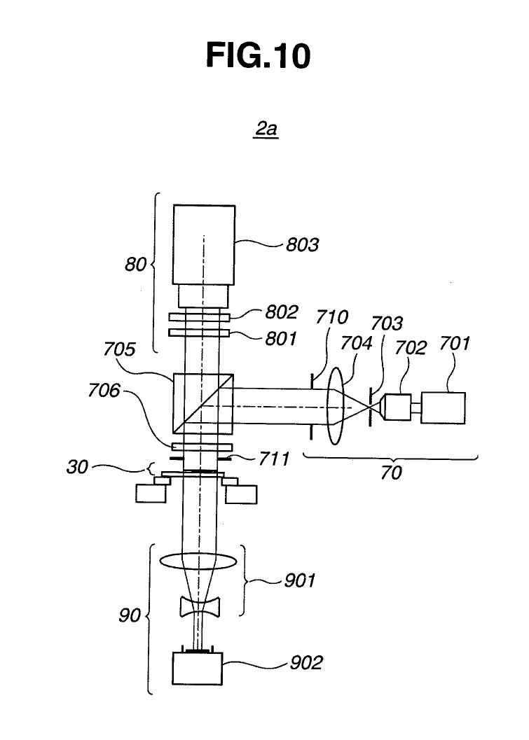

In the present exemplary embodiment, the transmitted light T is used by the existence region measuring unit 80 and the reflected light R is used by the surface shape measuring unit 90. However, as illustrated in FIG. 10, the positions of the existence region measuring unit 80 and the surface shape measuring unit 90 may be interchanged. This means that the reflected light R is used by the existence region measuring unit 80 and the transmitted light T is used by the surface shape measuring unit 90.

This configuration is effective when the wave front undulation due to the undulated surface shape of the cover glass 301 is larger to some extent than the wave front undulation due to the sample 302 and the slide glass 303.

Since the light amount of the transmitted light T penetrating the slide 30 is generally larger than the light amount of the reflected light R reflected by the slide 30, this configuration is effective when the wave front sensor 902 has a low sensitivity. FIG. 10 illustrates a measuring apparatus 2a which is a variation of the measuring apparatus 2.

With both the measuring apparatus 2 and the measuring apparatus 2a, one of the transmitted light T and the reflected light R is used by the existence region measuring unit 80 and the other one is used by the surface shape measuring unit 90, and the illumination unit 70 is shared between the existence region measuring unit 80 and the surface shape measuring unit 90. This enables reducing the size of the measuring apparatus and simultaneously measuring the existence region and the surface shape, shortening the measurement time.

The control apparatus 3 will be described below. The control apparatus 3 includes a computer which includes a central processing unit (CPU), a memory, and a hard disk. The control apparatus 3 controls the microscope 1 to capture an image of the slide 30, and processes data of the image of the slide 30 captured by the microscope 1 to create a digital image.

Specifically, the control apparatus 3 adjusts positions of a plurality of images captured while moving the slide stage 20 in the X and Y directions, and then stitches these images to create an image of the sample 302 without clearances.

The image acquisition apparatus according to the present exemplary embodiment captures an image of the sample 302 for each of the R, G, and B lights from the light source unit. So, the control apparatus 3 combines data of these images to create a color image of the sample 302.

The control apparatus 3 controls the microscope 1 and the measuring apparatus 2 so that the microscope 1 captures an image of the slide 30 based on a result of preliminary measurement of the slide 30 by the measuring apparatus 2. Specifically, the control apparatus 3 determines an imaging region to be captured by the microscope 1 based on the existence region of the sample 302 obtained by using the measuring apparatus 2, and then the microscope 1 captures an image of only the imaging region.

This enables capturing an image of only a region necessary for pathology diagnosis. As a result, the amount of digital image data of the slide 30 can be reduced to make it easier to handle the digital image data. Generally, the imaging region is determined so that it becomes equal to the existence region.

The control apparatus 3 further calculates an in-focus plane (in-focus curved surface) of the image of the sample 302 based on the surface shape of the cover glass 301 obtained by using the measuring apparatus 2 and the magnification of the objective lens 40.

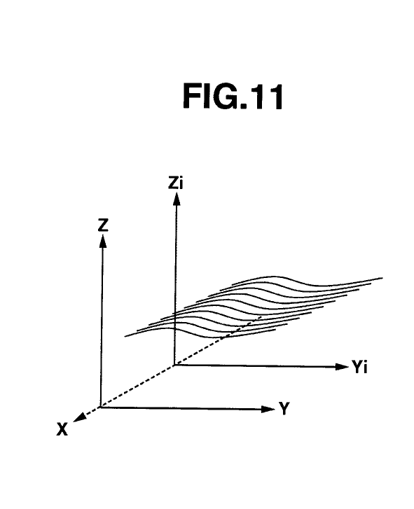

FIG. 11 is a schematic view illustrating the calculated in-focus plane. When the surface of the cover glass 301 undulates, the in-focus plane of the sample 302 also undulates to form a curved surface. In this case, if an image of the sample 302 is captured in a state where the imaging surfaces of the image sensor group 555 are arranged on the same single plane, a certain imaging surface separates from the in-focus plane (in-focus position) and does not fit into the depth of focus of the objective lens 40.

As a result, an image portion of the sample 302 projected onto the certain imaging surface becomes out of focus, and so the image acquisition apparatus will acquire a digital image having a blurred portion.

With the image acquisition apparatus according to the present exemplary embodiment, based on the surface shape measured by the measuring apparatus 2, the movement mechanisms move image sensors having an imaging surface separate from the in-focus plane out of the image sensor group 555 to bring the imaging surfaces of the image sensors close to the in-focus plane. In this specification, “move” means changing the position and/or inclination. In the above-mentioned state, the image acquisition apparatus according to the present exemplary embodiment acquires an image of the sample 302 to acquire a preferable digital image having little blur.

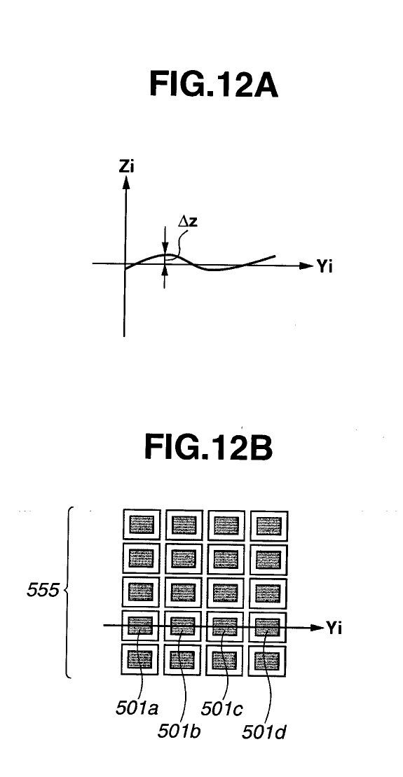

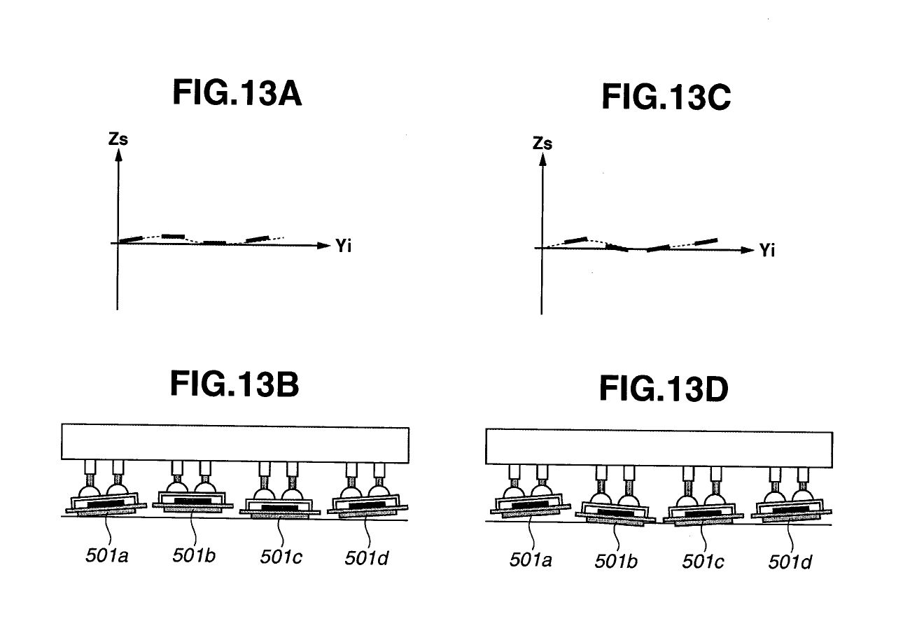

Image sensors will specifically be described below with reference to FIGS. 12A to 13D. FIGS. 12A and 12B illustrate image sensors arranged along the Yi axis. FIG. 12A illustrates an in-focus curve of the image of the sample 302. FIG. 12B is a top view illustrating the image sensor group 555.

FIGS. 13A to 13D illustrate a method for moving image sensors. FIG. 13A illustrates an in-focus curve of the image of the sample 302 and imaging surfaces of the image sensors 501a to 501d. FIG. 13B is a sectional view illustrating the imaging device 50. FIG. 13C illustrates an in-focus curve of the image of the sample 302 and imaging surfaces of the image sensors 501a to 501d. FIG. 13D is a sectional view illustrating the imaging device 50.

As illustrated in FIG. 12A, the in-focus curved surface of the image of the sample 302 forms a curve on a section including the Yi and Zi axes. As illustrated in FIG. 12B, the four image sensors 501a to 501d are arranged along the Yi axis. When the imaging surfaces of the image sensor group 555 are arranged on the Yi axis, the imaging surface of the image sensor 501b will be separate from the in-focus curve by ΔZ. When ΔZ is large and the imaging surface exceeds the depth of focus, the image at the relevant portion becomes out of focus.

To solve this problem, as illustrated in FIGS. 13A and 13B, the movement mechanisms move three image sensors 501a, 501b, and 501d out of the image sensors 501a to 501d, i.e., change their positions and/or inclinations so that the imaging surfaces of the image sensors 501a to 501d are almost in line with the in-focus curve. For example, FIG. 13B illustrates a state where the image sensors 501a and 501d are changed in both Z-directional position and Z-directional inclination, and the image sensor 501b is changed only in Z-directional position.

Since the imaging surface of the image sensor 501c fits into the depth of focus from the initial state, the movement mechanism does not need to move the image sensor 501c. Referring to FIG. 13A, the solid lines on the in-focus curves indicate the imaging surfaces of the image sensors 501a to 501d (this also applies to FIG. 13C).

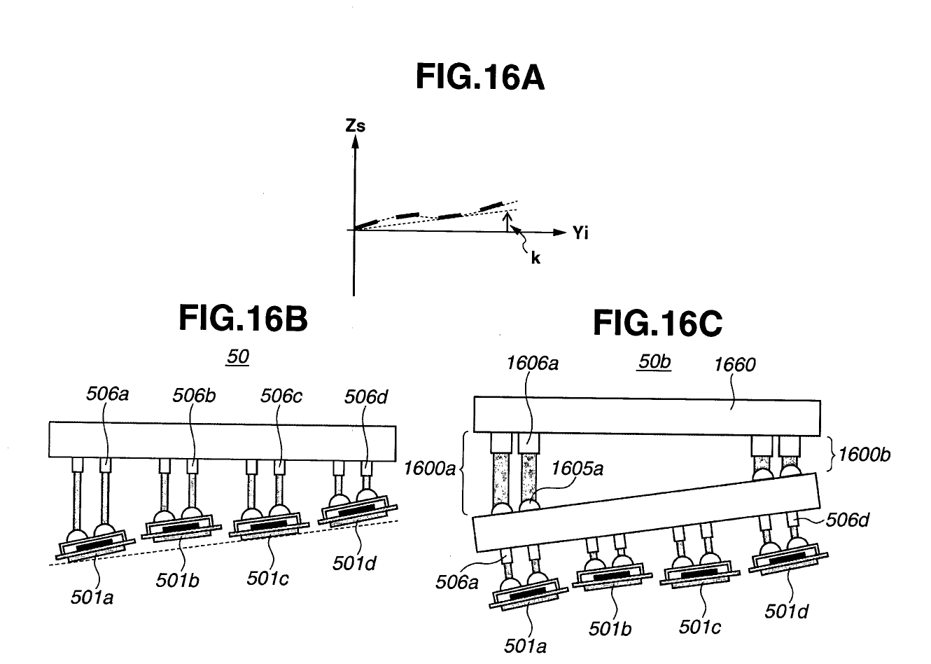

A case where the in-focus curved surface is inclined will be described below with reference to FIGS. 16A to 16C. In this specification, the case where the in-focus curved surface is inclined refers to a case where, when the in-focus curved surface is approximated to a flat plane, the flat plane is not in parallel with a plane including the X and Y axes.

First of all, a case where a curve of the in-focus curved surface on a section including Yi and Zi axes is not in parallel with the Yi axis will be described below. FIG. 16A corresponds to FIG. 13A. FIG. 16B corresponds to FIG. 13B. FIG. 16C is a sectional view illustrating an imaging device 50b which is a variation of the imaging device 50.

FIG. 16A illustrates a case where the in-focus curved surface of the image of the sample 302 is inclined by an inclination k. In this case, to bring the imaging surfaces of the image sensors 501a to 501d close to the in-focus curved surface, it is necessary to move the image sensors 501a to 501d with long strokes, as illustrated in FIG. 16B.

However, it may be difficult to create movement mechanisms 506a to 506d for moving the image sensors 501a to 501d with long strokes. In this case, the movement mechanisms may be divided into two groups, i.e., a first movement mechanism group (movement mechanisms 506a to 506d) and a second movement mechanism group (movement mechanisms 1600a and 1600b), as illustrated in FIG. 16C. The first movement mechanism group (movement mechanisms 506a to 506d) may correspond to the curved surface components of the in-focus curved surface, and the second movement mechanism group (movement mechanisms 1600a and 1600b) may correspond to the inclination of the in-focus curved surface.

The movement mechanism 1600a is composed of connecting members 1605a and moving members (cylinders) 1606a, and disposed on a top plate 1660 (this also applies to the movement mechanism 1600b). The second movement mechanism group (movement mechanisms 1600a and 1600b) moves the image sensor group (image sensors 501a to 501d) and the first movement mechanism group (movement mechanisms 506a to 506d) to adjust their inclinations.

When the inclination k of the in-focus curved surface is minimized by changing the inclination of the surface shape of the slide 30, the Z stage 24 of the slide stage 20 may be configured to move not only in the Z direction but also in the θx and θy directions, and the inclination of the slide 30 may be changed by the Z stage 24 instead of the second movement mechanism group. The inclination of the imaging device 50 may be changed by the imaging device stage 60 instead of the slide stage 20.

A definition of the inclination k will be considered below. Although, in FIG. 16A, the inclination k is considered with a sectional view, it is necessary to consider optimal inclinations in two directions (X and Y directions) since the image sensors 501 are two-dimensionally arranged.

Accordingly, it is necessary to calculate the inclinations of the image sensors 501a to 501d on an assumption that the image sensors 501a to 501d are inclined with respect to the X and Y axes centering on the center of the image sensor group 555 in FIG. 12B.

So, the Z-directional position of each image sensor is fit to a linear function by using the least-square method to obtain the inclination k, and a difference from the inclination k can be recognized as a curved surface. After the inclination k and the curved surface have been calculated, it is preferable to send movement instruction values from the control apparatus 3 to the first movement mechanism group (movement mechanisms 506a to 506d) and the second movement mechanism group (movement mechanisms 1600a and 1600b) in FIG. 16C.

By similarly applying the above-mentioned imaging surface movement control to other 16 image sensors of the image sensor group 555, all of the imaging surfaces of the image sensor group 555 become almost in line with the in-focus curve of the image of the sample 302, and all of the imaging surfaces of the image sensor group 555 fit into the depth of focus. By capturing an image of the sample 302 in this state, the image acquisition apparatus according to the present exemplary embodiment can acquire a preferable in-focus digital image without blur.

When moving the slide stage 20 (or the imaging device stage 60) in the X and Y directions and capturing again an image of the sample 302 to fill in clearances between the image sensors 501, the imaging surfaces of the image sensors 501a to 501d will separate from the in-focus curve by the movement of the slide stage 20.

As illustrated in FIGS. 13C and 13D, the movement mechanisms move again the image sensors 501 according to the movement of the slide stage 20 (or imaging device stage 60) in the X and Y directions so that the imaging surfaces of the image sensors 501 are brought close to the in-focus plane of the image of the sample 302.

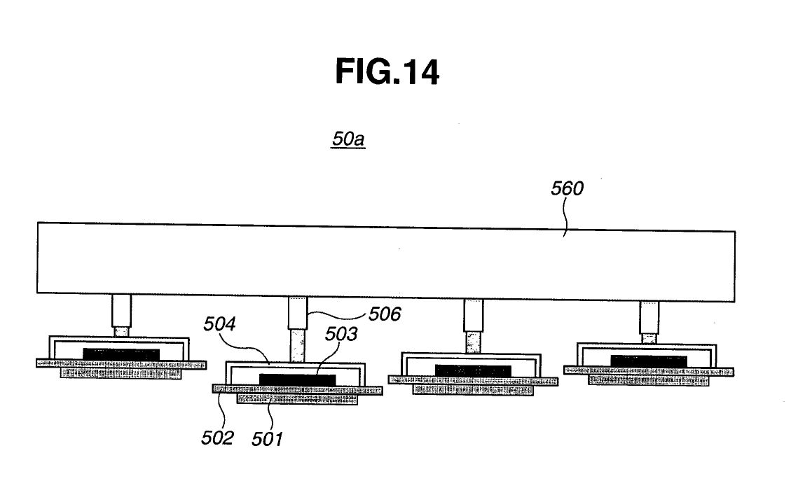

When the depth of focus is not so shallow, the movement mechanisms do not need to be configured to change both the positions and inclinations of the image sensors 501, but may be configured to change only the positions of the image sensors 501, as illustrated in FIG. 14. FIG. 14 illustrates an imaging device 50a which is a variation of the imaging device 50. Since the imaging region is predetermined as mentioned above, it is preferable to move only image sensors existing within the imaging region out of the image sensor group 555.

The display apparatus 4, e.g., an LCD display, is used to display operation screens necessary to operate the image acquisition apparatus 100, or display a digital image of the sample 302 created by the control apparatus 3.

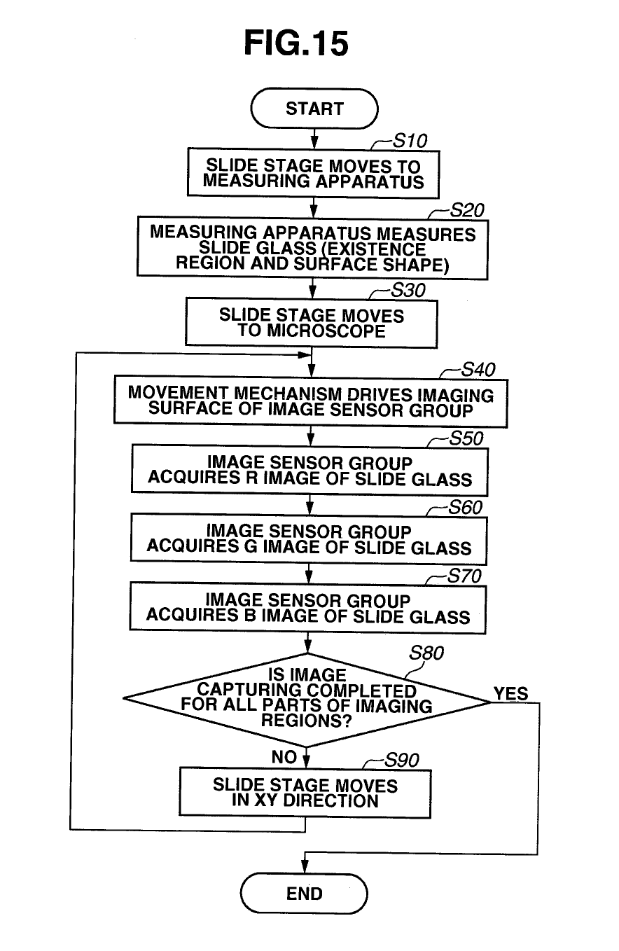

Processing by the image acquisition apparatus 100 according to the present exemplary embodiment will be described below with reference to the flow chart illustrated in FIG. 15.

In step S10, the slide 30 is taken out from a slide cassette, and then placed on the slide stage 20. Then, the slide stage 20 holding the slide 30 moves to the measuring apparatus 2. In step S20, the measuring apparatus 2 simultaneously measures the existence region (imaging region) on the slide 30 where the sample 302 exists and the surface shape of the slide 30. Measurement results are stored in a storage unit of the control apparatus 3. In step S30, the slide stage 20 moves from the measuring apparatus 2 to the microscope 1.

The image acquisition apparatus 100 calculates an in-focus curved surface of the sample 302 based on the surface shape stored in the storage unit of the control apparatus 3 and the magnification of the objective lens 40. In step S40, the movement mechanisms of the imaging device 50 move the imaging surfaces of the image sensors 501 so that the imaging surfaces of the image sensors 501 become in line with the calculated in-focus curved surface.

Although FIG. 15 illustrates that the slide stage 20 moves in step S30 and the movement mechanisms move the image sensors 501 in step S40, the processing in steps S30 and S40 may be executed simultaneously or in reverse order.

In steps S50 to S70, in a state where the imaging surfaces of the image sensors 501 are in line with the in-focus curved surface, the image sensor group 555 acquires an image of the sample 302. Specifically, in step S50, while the slide 30 is being illuminated by R (red) light from the illumination device 10, the image sensor group 555 acquires an R (red) image of the sample 302.

In step S60, the image acquisition apparatus 100 select G (green) light as the light to be emitted from the illumination device 10 and, while the slide 30 is being illuminated by the G light, the image sensor group 555 acquires a G (green) image of the sample 302. In step S70, the image acquisition apparatus 100 selects B (blue) light as the light to be emitted from the illumination device 10 and, while the slide 30 is being illuminated by the B light, the image sensor group 555 acquires a B (blue) image of the sample 302.

In-focus curved surfaces of the sample 302 by the R, G, and B light may differ from each other because of the influence of the chromatic aberration of the objective lens 40 or the influence of the shape or thickness of the cover glass 301. In this case, in-focus curved surfaces of the sample 302 by the R, G, and B light may be calculated in advance based on the surface shape stored in the storage unit of the control apparatus 3.

If the imaging surfaces of the image sensors 501 do not fit into the depth of focus, it may be preferable to change, before acquiring a G image and/or before acquiring a B image, the positions or attitudes of the image sensors 501 by using respective movement mechanisms so that the imaging surfaces are brought close to the in-focus curved surface and fit into the depth of focus. In this case, the positions or attitudes of the image sensors 501 may be changed by using the imaging device stage 60.

In step S80, it is determined whether image capturing is completed for all parts of imaging region. When images of the sample 302 at clearances between the image sensors 501 arranged in a matrix have not been acquired, i.e., image capturing is not completed for all parts of imaging region (NO in step S80), then in step S90, the image acquisition apparatus 100 moves the slide stage 20 in the X and Y directions to change the relative position between the slide 30 and the imaging device 50. Then, the processing returns to step S40. In step S40, the movement mechanisms move again the imaging surfaces of the image sensors 501. Insteps S50 to S70, the image sensor group 555 acquires again R, G, and B images of the slide 30, thus acquiring images of the sample 302 at clearances between the image sensors 501. On the other hand, if image capturing is completed for all parts of imaging region (YES in step S80), then, the processing ends.

Although, in the present exemplary embodiment, the image acquisition apparatus 100 changes the relative position between the slide 30 and the imaging device 50 by moving the slide stage 20, the imaging device stage 60 may be moved instead of the slide stage 20, or both the slide stage 20 and the imaging device stage 60 may be moved. When the image acquisition apparatus 100 repeats step S90 to move the slide stage 20 in the X and Y directions, step S40 to move the imaging surfaces of the image sensors 501, and steps S50 to S70 to acquire R, G, and B images a plurality of number of times (for example, three times), image capturing is completed for all parts of imaging region.

The image acquisition system 100 according to the present exemplary embodiment performs preliminary measurement on the surface shape of the slide 30 by using the measuring apparatus 2, and then captures an image of the slide 30 by using the microscope 1 based on the result of measurement, thus acquiring and displaying a preferable digital image having little blur.

Although preferable exemplary embodiments of the present invention have specifically been described, the present invention is not limited thereto, and can be modified in diverse ways within the ambit of the appended claims.

For example, although, in the above-mentioned exemplary embodiments, each image sensor is provided with one or more movement mechanisms, the configuration of the movement mechanisms is not limited thereto. Each two or more image sensors 501 may be provided with one or more movement mechanisms, and positions and/or inclinations may be adjusted for each two or more image sensors 501.

Although, in the above-mentioned exemplary embodiments, each image sensor is provided with one or more movement mechanisms, each image sensor does not need to be provided with one or more movement mechanisms when the depth of focus of the objective lens 40 is not so shallow or when the cover glass 301 does not largely undulates. In this case, it is preferable to adjust the Z-directional positions or inclinations of the image sensor group 555 at one time by using the imaging device stage 60, and also preferable to provide in the optical path of the objective lens 40 an optical element for changing aberration and move the optical element.

The image acquisition apparatus 100 captures an image of the slide 300 by using the microscope 1 based on the existence region and surface shape measured by the measuring apparatus 2. However, when the existence region and surface shape are known, the image acquisition apparatus 100 does not need to be provided with the measuring apparatus 2.

For example, information about the existence region and surface shape may be preferably recorded on the label 333 on the slide 30. In this case, providing on the microscope 1 an apparatus for reading the label 333 and capturing an image of the slide 300 by using the microscope 1 based on the read information enable acquiring a preferable digital image having little blur only with the microscope 1.

Although, in the above-mentioned exemplary embodiments, the image sensor group 555 composed of a plurality of two-dimensionally arranged image sensors is used, the configuration of the image sensor group 555 is not limited thereto. The image sensor group 555 may be composed of a plurality of one- or three-dimensionally arranged image sensors. Although, in the above-mentioned exemplary embodiments, two-dimensional image sensors are used, the type of image sensors is not limited thereto. One-dimensional image sensors (line sensors) may be used.

Although, in the above-mentioned exemplary embodiments, a plurality of image sensors is arranged on the same single substrate (top plate), the arrangement of the image sensors is not limited thereto. A plurality of image sensors may be arranged on a plurality of substrates as long as images of a plurality of different portions of the slide 300 can be simultaneously captured.

The technical elements described in the specification or the drawings can exhibit technical usefulness, either alone or in combination, and combinations are not limited to those described in the claims as filed. The techniques illustrated in the specification or the drawings can achieve a plurality of purposes at the same time, and achieving only one of them has technical usefulness.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-243802 filed Oct. 29, 2010, No. 2010-243803 filed Oct. 29, 2010, and No. 2011-190375 filed Sep. 1, 2011, which are hereby incorporated by reference herein in their entirety.

1. A microscope for capturing an image of an object, comprising:
an illumination device configured to illuminate the object;
an optical system configured to form an image of the object; and
an imaging device for capturing the image of the object,
wherein the imaging device includes a plurality of imaging units, and
wherein each of the imaging units includes an image sensor and a movement mechanism for moving the image sensor.

2. The microscope according to claim 1, wherein the movement mechanism moves the image sensor so that an imaging surface of the image sensor is brought close to an in-focus plane of the image of the object.

3. The microscope according to claim 1, wherein the movement mechanism moves the image sensor according to a surface shape of the object.

4. The microscope according to claim 1, further comprising:
a stage configured to hold and move the object,
wherein the movement mechanism moves the image sensor according to a movement of the stage in a direction perpendicular to an optical axis of the optical system.

5. The microscope according to claim 1, wherein the imaging device includes a first movement mechanism group including a plurality of the movement mechanisms and a second movement mechanism group for moving the imaging units.

6. The microscope according to claim 5, wherein the second movement mechanism group moves the imaging units according to the inclination of an in-focus curved surface of the image of the object.

7. The microscope according to claim 1, further comprising:
a stage configured to hold and move the object,
wherein the stage moves the object according to the inclination of the in-focus curved surface of the image of the object.

8. The microscope according to claim 1, wherein a plurality of the image sensors is configured to capture images of a plurality of different portions of the object.

9. An image acquisition apparatus for acquiring an image of a object, the image acquisition apparatus comprising:
the microscope according to claim 1; and
a measuring apparatus for measuring a surface shape of the object,
wherein the movement mechanism of the microscope moves the image sensor according to the surface shape measured by the measuring apparatus.

10. The image acquisition apparatus according to claim 9, wherein the measuring apparatus measures an existence region where a sample of the object exists, and
wherein the microscope moves the image sensor for capturing an image of the existence region according to the surface shape and the existence region measured by the measuring apparatus.

11. The image acquisition apparatus according to claim 10, wherein the measuring apparatus includes a surface shape measuring unit for measuring the surface shape by using light reflected by the object, and an existence region measuring unit for measuring the existence region by using light passing through the object.

12. The image acquisition apparatus according to claim 10, wherein the measuring apparatus includes:
an illumination unit for illuminating the object with light;
a surface shape measuring unit for measuring the surface shape by using one of the light penetrating the object and the light reflected by the object; and
an existence region measuring unit for measuring the existence region by using the other one of the light penetrating the object and the light reflected by the object.

13. An image acquisition system comprising:
the image acquisition apparatus according to claim 9; and
a display apparatus configured to display the image of the object acquired by the image acquisition apparatus.
